(19) United States
(12) Patent Application Publication
(10) Pub. No.: US 2005/0228689 A1
(43) Pub. Date: Oct. 13, 2005

(54) System and Method for Fabricating Informational Placard

(76) Inventor: Glen Hagood, Pflugerville, TX (US)

Correspondence Address: TAYLOR RUSSELL & RUSSELL, P.C., 4807 SPICEWOOD SPRINGS ROAD, BUILDING TWO SUITE 250, AUSTIN, TX, 78759, US

(21) Appl. No.: 11/160,482

(22) Filed: Jun. 27, 2005

Related U.S. Application Data
(63) Continuation-in-part of application No. 10/604,577, filed on Jul. 31, 2003.

(51) Int. Cl. G06F 17/60

(52) U.S. Cl. 705/1

(57) ABSTRACT

A computer augmented system and method for fabricating informational placards that may be used in applications such as temporary license plates or tags, or handicap parking placards. The placards are configurable to meet the requirements of various state and other regulatory agencies, and are typically displayed in a prominent location of a motor vehicle. The system comprises a computer system having a user interface, a barcode scanner, access to one or more databases, and a suitable printer for imprinting labels. The labels produced by the printer may be affixed to substrates using a suitable adhesive to form placards that are positioned on a motor vehicle for displaying information. The method comprises entering information into a computer system and accessing information from a suitable database, entering or barcode scanning vehicle identification numbers, printing transparent or opaque labels, and affixing the transparent or opaque labels to substrates to form informational placards.

This application is a continuation-in-part of U.S. non-provisional patent application Ser. No. 10/604,577, filed Jul. 31, 2003, which is incorporated herein by reference.

### BACKGROUND

The invention relates generally to the field of informational display, and particularly to placards for displaying information available to the general public. More particularly, the invention provides for informational placards that meet the requirements of regulatory agencies such as state motor vehicle and public safety agencies. Although the present invention is described in terms of primarily temporary motor vehicle registration placards, its application is considerably broader in scope and application.

Most states have agencies that regulate the manner in which information is displayed on certain placards, such as temporary motor vehicle license plates or tags, and handicap parking tags. The size, type and placement of information contained on these placards is regulated to ensure it is easily and unambiguously discernable by law enforcement officials. The information may be fixed and variable. Generally, the most prominent variable information displayed is the expiration date of the placard. For temporary placards, the expiration date of the placard is most often designated as being between two and four weeks from the date of issue of the placard. For motor vehicles, the expiration date allows sufficient time for a purchaser of a vehicle from a dealer to register the motor vehicle and obtain non-temporary license plates. Other variable information may be vehicle make, purchaser's name, vehicle identification number (VIN), name of a sales person, a serial number, and date of issue. Fixed information may be pre-printed on a placard as a template, such as a dealer's name, address and number, duration of validity of the placard, and designated use, such as for motor vehicles.

Although there may be stringent requirements for the placement of information on placards, the placement of the information is usually not strictly enforced as long as some expiration date is identifiable. Since the information on many placards is created by a salesperson using a felt-tipped pen, the placard information may not comply with requirements in information size, type, placement or accuracy. In some cases, the information on a placard may be incomplete. In addition, hand printed characters on a placard may not present a desired commercially professional image for a dealer whose name appears on the placard.

In motor vehicle applications, temporary license placards are positioned in a rear window or in a license plate holder. Placement in a rear window oftentimes creates a problem of visibility where a rear window is darkly tinted to reduce entry of excessive sunlight. It is sometimes difficult to discern regulatory required colored characters on a placard positioned in a tinted rear window. When positioned in a license plate holder, a temporary placard is subjected to conditions found on roadways, including sun, rain, snow, dirt and wind. Since many of these placards are of paper or cardboard construction, these conditions can render some temporary placards distorted and unreadable within a short time.

A prior method for alleviating these environmental related problems has been to hand print the necessary characters on a placard of paper or cardboard and cover the printed characters with transparent film. This approach has proved to be unsuccessful for several reasons. Although the effects of roadway conditions were reduced, they were not eliminated because the characters were printed on materials of paper or cardboard that are readily soluble in water. In addition, the problems of incorrect or incomplete information hand printed on the placards by dealers have not been addressed.

### SUMMARY

The present invention provides a system and method for fabricating informational placards that are able to tolerate severe roadway conditions without discernable deterioration prior to the expiration date. It also provides placards that comply with regulatory requirements in terms of information size, type, placement, completeness and accuracy. Because of the high quality of the printed characters on the placard according to the present invention, the placard provides a commercially professional image.

The present invention is a system and method for fabricating informational placards that results in a regulatory compliant placard easily positioned on an appropriate vehicle for display of temporary registration expiration. The finished placard must have a relatively stiff property in order to hold its shape under exposure to deleterious weather road conditions. It comprises a substrate having a smooth surface for imprinting information that meets regulatory requirements. Although a weather and tamper resistant substrate having a smooth surface may be supplied directly for imprinting purposes, most printers do not possess a capability of handling material that meets stiffness requirements to function as a placard. Therefore, a finished imprinted placard that can be easily fabricated with commonly used printers, such as laser, inkjet and thermal printers, comprises a substrate and an adhesive backed label affixed to the substrate. The substrate may be blank or may be imprinted with fixed information. If the substrate is blank without imprinted information, all of the information required to be displayed is imprinted on the adhesive backed label, and the adhesive backed label may be either optically transparent or opaque. If the substrate is imprinted with information, normally information of a fixed nature, the adhesive backed label would be imprinted with information, normally of a variable nature, and the adhesive backed label would normally be selected to be optically transparent to enable display of the information imprinted on the substrate and the label. When the label is affixed to the substrate, the resultant placard contains all information required to comply with various jurisdictional regulatory requirements. These various regulatory requirements may require placards of different sizes to be imprinted with different information, depending on the particular jurisdiction. A computer-augmented method comprises a computer software program having capabilities for identifying a salesperson responsible for closing a purchase transaction, accepting a purchaser's name from a user interface and reading a vehicle identification number (VIN) of a newly purchased vehicle. The computer program determines an expiration date for the temporary vehicle placard based on the current date, accesses detailed vehicle information from a database based in the VIN, and then causes the variable information comprising a current date, an expiration date, VIN, vehicle model year, vehicle make, vehicle model, a serial number, vehicle purchaser name and salesperson name to be printed on a label. The label is capable of being affixed to a substrate that is then mounted in a vehicle license plate holder or made clearly visible in a vehicle rear window. The capability of accommodating various jurisdictional requirements is accomplished by different size labels and substrates, and by different placard informational and format templates accessed by the computer program.

The VIN may be keyed in or barcode scanned to improve accuracy and speed. The salesperson may be selected from a list of salespersons employed by a motor vehicle dealer. The VIN is validated against a VIN database where the vehicle model year, vehicle make and vehicle model may be extracted. A purchaser's name may be manually keyed in and a salesperson's name may be keyed in or selected from a database list available to the computer program. The computer program then causes the required information to be sent to a printer where the information is printed on the label. The label comprises an optically transparent or opaque film having a permanent clear self-adhesive on one side and a glossy finish on the opposite side where information is to be imprinted. The label is capable of being affixed to many different kinds of substrate surfaces, including a cardboard or paper substrate under an application temperature of at least 40° F., and has a service range of from −60° F. to 200° F. Since a laser, inkjet or thermal printer may produce the printed information, the visual quality of the printed information is extremely good. The printed information may include fixed and variable information such as dealer name, number and location, state of registration, and intended use.

An embodiment of the present invention is a method for fabricating informational placards comprising the steps of entering a name of an applicant for an informational placard and an issuing agent of an informational placard into a computer system by a system user via a user interface for obtaining an informational placard, determining an expiration date of the informational placard based on the current date by the computer system, entering a vehicle identification number into the computer system by the system user via the user interface for accessing information on a vehicle identified by the vehicle identification number from a database, accessing information required by regulatory agencies on informational placards from a database by the computer system, printing the required information on a substrate using a printer connected to the computer system to form the informational placard containing the expiration date, the vehicle identification number and the information required by regulatory agencies, and positioning the informational placard on the identified vehicle. The step of entering a name of an applicant for an informational placard may comprise selecting the name of the applicant from a list of applicants presented to the user via the user interface, the list of applicants accessed from a database. The step of entering a name of an issuing agent of an informational placard may comprise selecting the name of the issuing agent from a list of issuing agents presented to the user via the user interface, the list of issuing agents accessed from a database. The step of determining an expiration date further may comprise adding a time duration period to the current date, the added time duration being determined by regulatory requirements. The step of entering a vehicle identification number may comprise scanning a bar code representation of the vehicle identification number into the computer system using a bar code scanner. The step of accessing information may be selected from the group consisting of accessing a driver permit number of the placard applicant, accessing a serial number, accessing specific vehicle information, accessing an issuer permit number of the issuer agent, accessing a name of a vehicle dealership, accessing a dealer permit number of a vehicle dealership, accessing a location of a vehicle dealership, and accessing template information regarding placard size and placard information requirements. The step of printing the required information on a substrate may be selected from the group consisting of printing on a substrate using a laser printer, printing on a substrate using an inkjet printer and printing on a substrate using a thermal printer. The step of printing on a substrate to form an informational placard may comprise printing the required information on a label using a printer connected to the computer system, the label imprinted with variable information including the expiration date and the vehicle identification number and fixed information required by regulatory agencies, and affixing the label to a substrate using an adhesive means to form an informational placard. The step of printing on a substrate to form an informational placard may comprise printing the required information on an optically opaque label using a printer connected to the computer system, the label imprinted with variable information including the expiration date and the vehicle identification number and fixed information required by regulatory agencies, and affixing the label to a blank substrate using an adhesive means to form an informational placard. The step of printing on a substrate to form an informational placard may comprise printing the required information on an optically transparent label using a printer connected to the computer system, the label imprinted with variable information including the expiration date and the vehicle identification number and fixed information required by regulatory agencies, and affixing the label to a blank substrate using an adhesive means to form an informational placard. The step of printing on a substrate to form an informational placard may comprise printing the required information on an optically transparent label using a printer connected to the computer system, the label imprinted with variable information including the expiration date and the vehicle identification number, and affixing the label to a pre-printed substrate containing fixed information required by regulatory agencies using an adhesive means to form an informational placard. The step of affixing the optically transparent label to the pre-printed substrate may comprise positioning the transparent label on the substrate by aligning label printed characters with corresponding character positions imprinted on the substrate and securing the transparent label to the substrate using weatherproof adhesive means. The step of positioning the informational placard may be selected from the group consisting of positioning the informational placard in a license plate holder of the identified vehicle, positioning the informational placard in a window of the identified vehicle, and positioning the informational placard on a bumper of the identified vehicle. The label may be pre-printed with fixed information determined by regulatory requirements. The pre-printed fixed information may be selected from the group consisting of background designs, colors, watermarks, distinguishing features and a refractive image. The step of accessing information may be selected from the group consisting of accessing information by a standalone computer system connected to a local database, accessing information by a client-server computer system connected to a database, accessing information by a computer system connected to a remote database system via the Internet, and accessing information by a computer system connected to a remote database system via a data communications network.

Another embodiment of the present invention is a system for fabricating informational placards, comprising a user interface for entering a name of an applicant for an informational placard and an issuing agent of an informational placard into a computer system by a system user for obtaining an informational placard, computer means for determining an expiration date of the informational placard based on the current date, means for entering a vehicle identification number into the computer system by the system user via the user interface for accessing information on a vehicle identified by the vehicle identification number from a database, means for accessing information required by regulatory agencies on informational placards from a database by the computer system, means for printing the required information on a substrate using a printer connected to the computer system to form an informational placard containing the expiration date, vehicle identification number and the information required by regulatory agencies, and means for positioning the informational placard on the identified vehicle. The system may further comprise the user interface for displaying a list of names of applicants for informational placards accessed from a database, a name of an applicant for an informational placard being selected from the list of names of applicants by a user. The system may further comprise the user interface for displaying a list of names of issuing agents of informational placards accessed from a database, a name of an issuing agent being selected from the list of names of issuing agents by a user. The means for entering a vehicle identification number may comprise a bar code scanner for scanning a bar code representation of the vehicle identification number into the computer system. The information required on informational placards by regulatory agencies may be selected from the group consisting of a driver permit number of the placard applicant, a serial number, specific vehicle information, an issuer permit number of the issuer agent, a name of a vehicle dealership, a dealer permit number of a vehicle dealership, a location of a vehicle dealership, and template information regarding placard size and placard information requirements. The means for printing required information may be selected from the group consisting of a laser printer, an inkjet printer and a thermal printer. The substrate may comprise a material selected from the group consisting of paperboard, cardboard, metal and plastic. The substrate may be pre-printed with fixed information determined by regulatory requirements. The pre-printed fixed information may be selected from the group consisting of background designs, colors, watermarks, distinguishing features and a refractive image. The means for printing on a substrate to form an informational placard may comprise means for printing the required information on a label using a printer connected to the computer system, the label imprinted with variable information including the expiration date and the vehicle identification number and fixed information required by regulatory agencies, and adhesive means for affixing the label to a substrate to form an informational placard. The means for printing on a substrate to form an informational placard may comprise means for printing the required information on an optically opaque label using a printer connected to the computer system, the label imprinted with variable information including the expiration date and the vehicle identification number and fixed information required by regulatory agencies, and adhesive means for affixing the label to a blank substrate to form an informational placard. The means for printing on a substrate to form an informational placard may comprise means for printing the required information on an optically transparent label using a printer connected to the computer system, the label imprinted with variable information including the expiration date and the vehicle identification number and fixed information required by regulatory agencies, and adhesive means for affixing the label to a blank substrate to form an informational placard. The means for printing on a substrate to form an informational placard may comprise means for printing the required information on an optically transparent label using a printer connected to the computer system, the label imprinted with variable information including the expiration date and the vehicle identification number, and adhesive means for affixing the label to a pre-printed substrate containing fixed information required by regulatory agencies to form an informational placard. The information placard may be selected from the group consisting of a temporary license plate and a disabled parking placard. The formed informational placard may be durable, tamper resistant and weather resistant. The label may be pre-printed with fixed information determined by regulatory requirements. The pre-printed fixed information may be selected from the group consisting of background designs, colors, watermarks, distinguishing features and a refractive image. The means of accessing information may be selected from the group consisting of a standalone computer system connected to a local database, a client-server computer system connected to a database, a computer system connected to a remote database system via the Internet, and a computer system connected to a remote database system via a data communications network.

Yet another embodiment of the present invention is a system for fabricating informational placards, comprising a computer connected to a user interface, at least one database, a barcode scanner, and a printer, a substrate imprinted with information by the printer to form an informational placard, and means for displaying the informational placard. The imprinted information on the substrate may be selected from the group consisting of variable information, and fixed plus variable information. The information imprinted on the information placard may conform to regulatory agency requirements. The substrate may comprise a label imprinted with information, and a substrate for adhesively mounting the label. The label may be pre-printed with information. The substrate may be pre-printed with information.

### BRIEF DESCRIPTION OF THE DRAWINGS

These and other features, aspects and advantages of the present invention will become better understood with regard to the following description, appended claims, and accompanying drawings wherein:

FIGS. 1A-1C show system diagrams for fabricating informational placards;

FIG. 2 shows a flow diagram of a method for fabricating informational placards;

FIG. 3 depicts an embodiment of a substrate imprinted with fixed information according to the disclosed invention;

FIG. 4 depicts an embodiment of a label imprinted with variable and fixed information according to the disclosed invention;

FIGS. 5A and 5B depict an initial step of securing an imprinted transparent label to a substrate; and

FIGS. 6A and 6B depict a finished information placard after a final step of folding a top part of the imprinted transparent label over an opposing side of a substrate according to the disclosed invention.

### DETAILED DESCRIPTION OF THE DRAWINGS

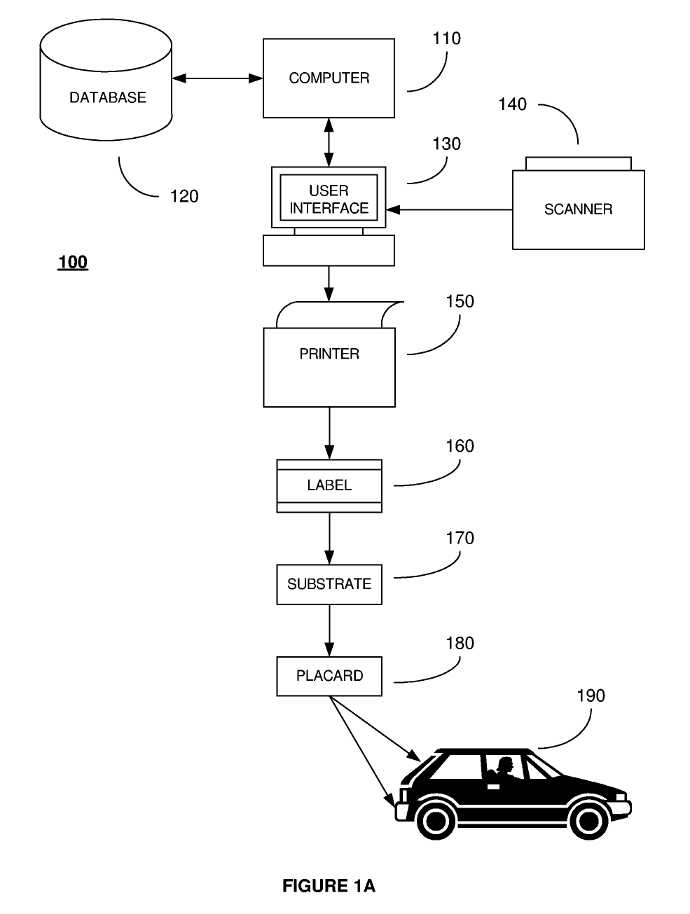

Turning now to FIG. 1A, FIG. 1A shows a system diagram 100 of a stand-alone computer system for fabricating informational placards. It is a hardware/software solution for filling out temporary license plates, disabled parking placards or other permits that are issued on behalf of a governing authority or state by automobile dealers or agents of the governing authority or state. A user interface 130 is connected to a computer 110 for selecting a vehicle salesperson or licensing agent responsible for issuing a placard and for entering a customer's or license applicant's name into the system. Any entered information on the user interface 130 may be transmitted to a regulatory agency via a modem connected to the computer 110. A VIN may also be entered into the system via the user interface 130, or may be scanned as a barcode into the system using a barcode scanner 140 connected to the user interface 130. The computer 110 uses the VIN to access a database 120 connected to the computer 110 and containing vehicle information identified by the VIN. The computer 110 causes a printer 150 connected to the user interface 130 to print information on a label 160 in a predefined format based on a template stored in the database 120, determined by a regulatory agency. The printer 150 may be a laser printer, an inkjet printer or a thermal printer. If the printer 150 used for generating the placards is capable of feeding preprinted or blank weather resistant substrate stock material, such as cardboard, the fixed and variable label information may be printed directly on the substrate stock to form a placard, making it unnecessary to print a label separate from a substrate for attachment to the substrate. A placard 180 may also be generated using a printer capable of feeding preprinted or blank plastic substrate stock material by printing fixed and variable label information directly on the plastic substrate material, eliminating the need for separate label and substrate handling. The label material used with a laser or inkjet printer may be optically clear or opaque material, such as polyester or teslin, having a glossy face stock with permanent self-adhesive backing. The printed result from a laser or inkjet printer are water, solvent and scuff resistant, suitable for indoor and short-term outdoor applications. The adhesive, such as a clear acrylic, is adaptable to many surfaces with a minimum application temperature of 40° F. and a service temperature range of from −60° F. to 200° F. The transparent or opaque label material used with a thermal printer may be a glossy clear or opaque material, such as polystyrene, treated for thermal transfer printing, with an adhesive backing of a general-purpose permanent hot melt rubber base material having a minimum application temperature of 25° F. and a service temperature range of from −65° F. to 150° F. The ink used with the thermal printing process has superior chemical and heat resistant properties as well as superior print quality. The data printed on the label 160 may vary from one jurisdiction to another, and is determined by the governing authority or state. This information to be printed on the label 160 may be keyed in, scanned in, or extracted from a database 120. The information printed on the label 160 may include information required by regulatory agencies, such as the salesperson's or licensing agent's name, the purchaser's or license applicant's name, motor vehicle information, a serial number and VIN, serial number and expiration date. The imprinted label 160 is affixed to a substrate 170, which may have preprinted fixed information thereon, using a suitable adhesive to form a placard 180. The stock for the label 160 may be furnished to the user previously preprinted on a printing press with backgrounds, screens, colors, watermarks or other distinguishing features required by regulatory agencies. The stock for the label 160 may also incorporate a refractive image, such as a hologram, for security and tamper resistance. The substrate 170 may be imprinted cardboard material furnished by a governing authority or state to an agent, but may also be purchased directly from a printing company that is licensed by the governing authority or state. Other substrate material may include paperboard, plastic or metal. The fixed preprinted information on the substrate 170 may include locations designated for motor vehicle name, number and location, state designation and duration of validation of the placard. The informational placard 180 may be positioned on a window, bumper or license plate holder of a vehicle 1 90. The temporary permit or informational placard 180 is issued to a motorist for a short period of time, typically for a month or less, while the motorist awaits permanent license plates or permanent placard to be issued. Temporary informational placards 180 may also be issued for moving an unlicensed motor vehicle from one location to another.

Turning to FIG. 1B, FIG. 1B is similar to FIG. 1A, except that the computer 110 shown in FIG. 1A is replaced by a server computer 112 connected to one or more client user interfaces 132,134,136 instead of a single user interface 130 as in FIG. 1A. Any entered information on the user interface 132 may be transmitted to a regulatory agency via a modem connected to the server computer 112. Otherwise, the operation of this configuration is as described above in relation to FIG. 1A.

Turning to FIG. 1C, FIG. 1C is similar to FIG. 1A, except that the computer 110 connected directly to the user interface 130 shown in FIG. 1A is replaced by a computer 114 connected to a user interface 138 via a data communications network such as the Internet 116. Any entered information entered on the user interface 138 may be transmitted to a regulatory agency via the Internet connected to the computer 114. Otherwise, the operation of this configuration is as described above in relation to FIG. 1A.

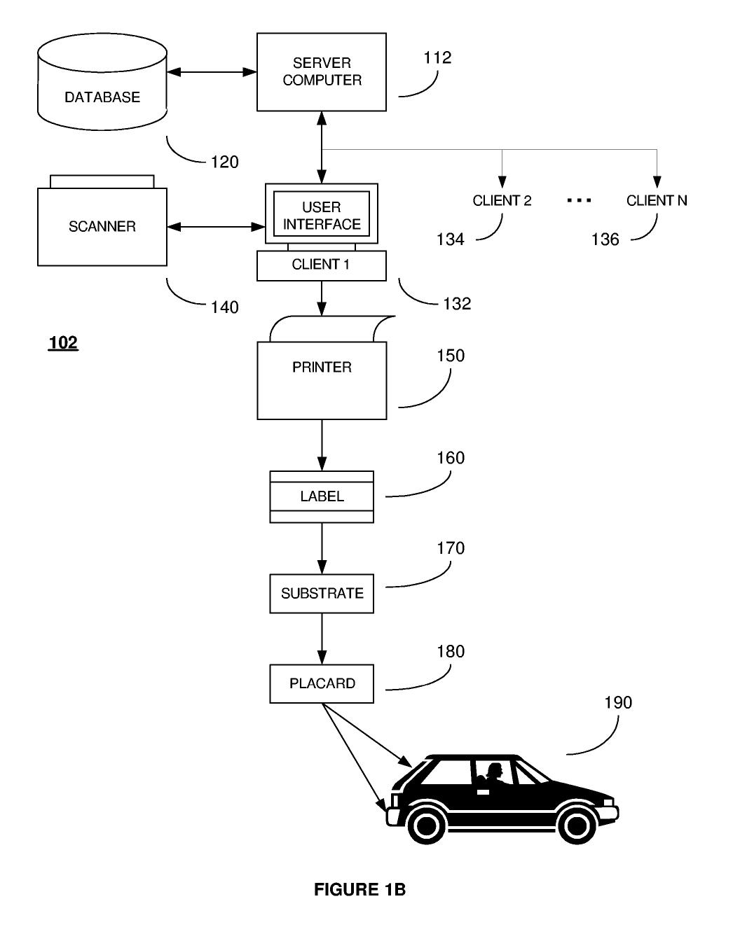

Turning now to FIG. 2, FIG. 2 shows a flow diagram 200 of a method for fabricating informational placards. Once the method is started 210, a user such as a salesperson responsible for a sale of a motor vehicle or a licensing agent is selected or entered into the system 220 via a user interface 130. A name of a purchaser of a motor vehicle or license applicant is also entered into the system 230 via the user interface 130. The system automatically determines an expiration date 240 based on a current date and the period of validity of the informational placard. A VIN is either entered or barcode scanned via a scanner 140 into the system 250 enabling vehicle data to be accessed 260 from a database 120 containing vehicle data. Information is the printed on a transparent or opaque label 270 by a printer 150, and may include the salesperson's or licensing agent's name, purchaser's or license applicant's name, placard expiration date, vehicle information, a serial number and VIN. The imprinted transparent or opaque label 270 is then affixed to a substrate 280 using a suitable adhesive to form an informational placard. The informational placard is then installed on a vehicle 290.

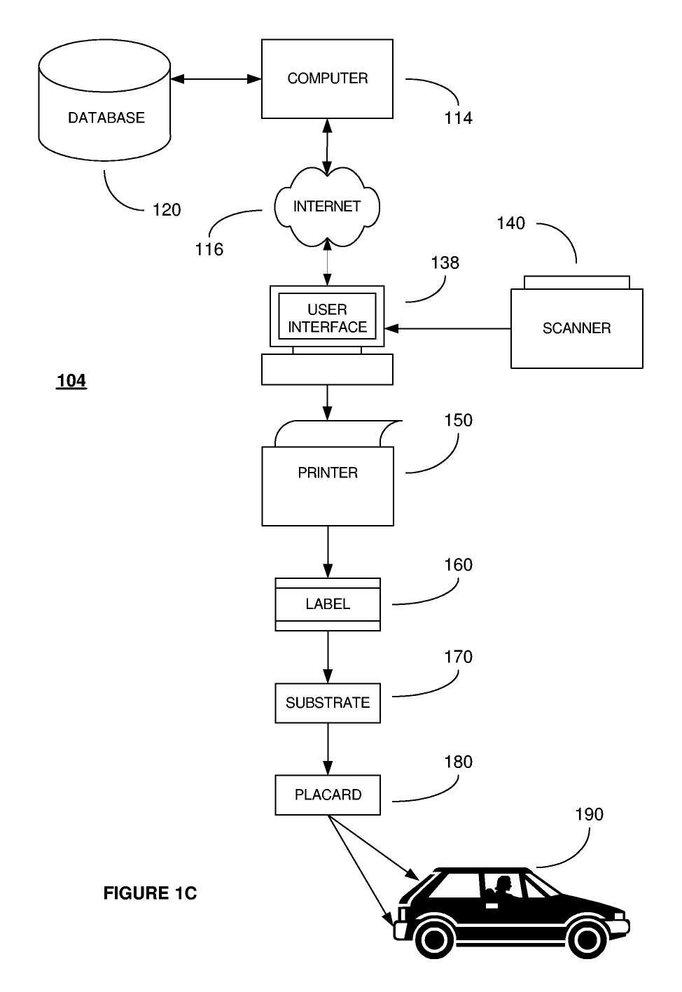

Turning now to FIG. 3, FIG. 3 depicts an embodiment of a substrate 300 imprinted with fixed information according to the disclosed invention. Locations are provided on the substrate for displaying required placard information of a fixed nature. The dominant information to be displayed on the substrate is a six-digit expiration date comprising a numeric month designation 310, a numeric day-of-the-month designation 320 and a numeric year designation 330. Locations for other information to be displayed may include make of vehicle 340, VIN 350, date the license was issued or vehicle sold 360, the buyer's or applicant's name 370, and the salesperson's or licensing agent's name. The substrate 300 may also be blank with no imprinted information. Different size substrates 300 may also be available to satisfy the requirements of various regulatory jurisdictions. The substrate 300 may comprise a semi-rigid material, such as cardboard and plastic.

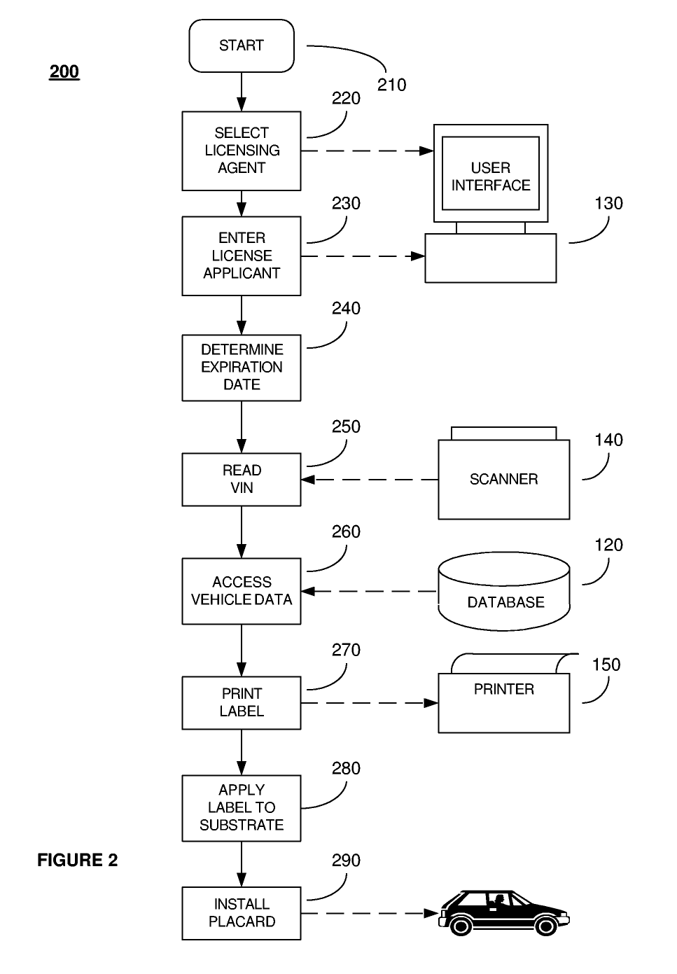

Turning to FIG. 4, FIG. 4 depicts an embodiment of a transparent or opaque label 400 imprinted with information according to the disclosed invention. Variable imprinted information may include a state name 404, a name of a car dealership 402, a dealer identification number 406, a six digit expiration date 410 as described in relation to FIG. 3 above, specific vehicle information 440, a VIN 450, a serial number 455, a vehicle purchase date or license issue date 460, a purchaser's or license applicant's name 470, a salesperson's or licensing agent's name 480, and a dealer or agent location 408. The specific vehicle information 440 may include the vehicle make, model year, and color. Fixed information may also be imprinted on the label 400, as described in relation to FIG. 3 above. If the substrate 300 described in relation to FIG. 3 above has no imprinted information, and all the placard information to satisfy regulatory requirements is imprinted on the label 400, the label may comprise an optically opaque material. The present invention is also capable of accommodating various size labels 400 and information requirements to satisfy various jurisdictional requirements.

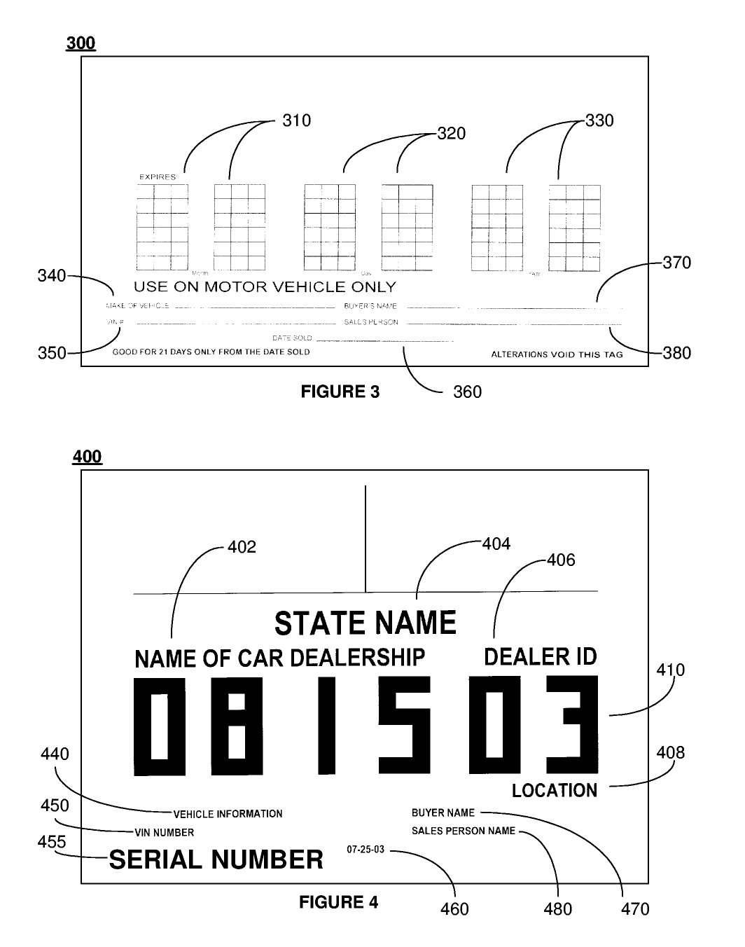

Turning to FIGS. 5A and 5B, FIG. 5A and FIG. 5B depict an initial step 500 of securing an imprinted optically transparent or opaque label 400 to a side of a substrate 300. FIG. 5A depicts a front view of a partially constructed placard and FIG. 5B depicts a side view of the partially constructed placard. The imprinted transparent or opaque label 400 containing information is adhered to the substrate 300 containing information using a suitable adhesive. When a substrate 300 contains imprinted fixed information and a transparent label 400 contains imprinted variable information, care must be taken to align the information locations provided on the front imprinted substrate 300 with the variable information imprinted on the transparent label 400. Once the imprinted label 400 is securely positioned to a front side of the substrate 300, as shown in FIG. 5A, a top part 490 of the label 400 is folded over a top and backside of the substrate 300 and a bottom part 495 of the label 400 is folded over a bottom and backside of the substrate 300, as indicated by the broken circular arrow shown in FIG. 5B.

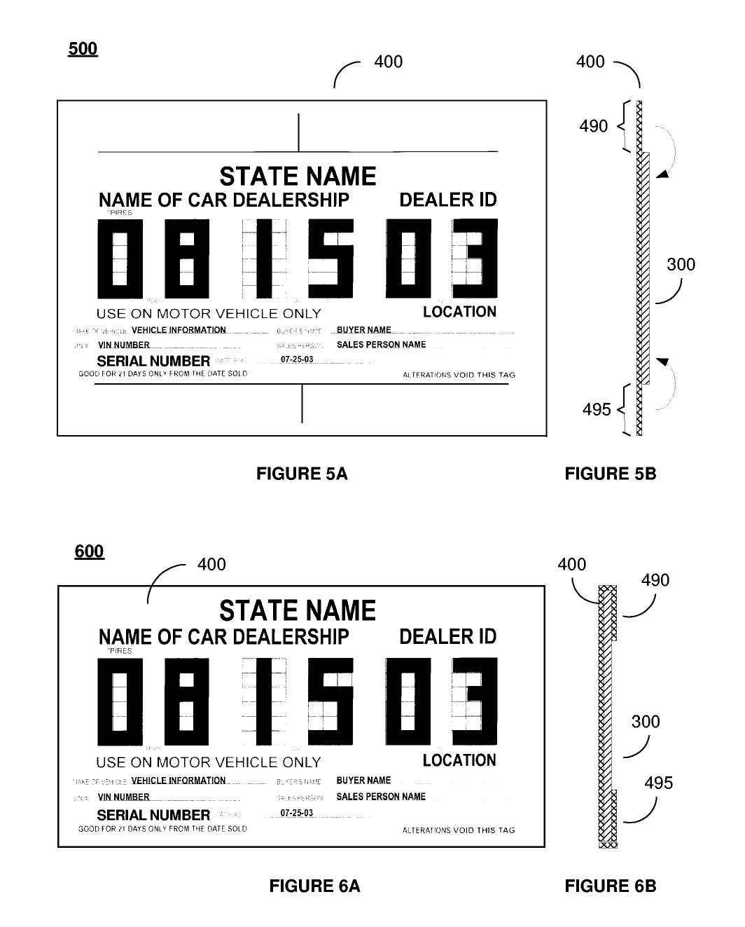

Turning to FIGS. 6A and 6B, FIG. 6A and FIG. 6B depict a finished information placard 600 after a final step of folding a top part 490 of the imprinted label 400 over an opposing side of a substrate 300 and folding a bottom part 495 of the imprinted label 400 over an opposing side of a substrate 300, according to the disclosed invention. FIG. 6A depicts a front view of a finished placard and FIG. 6B depicts a side view of the finished placard. As indicated in FIGS. 6A, when imprinted information is contained on a transparent label 400 and imprinted information is contained on the imprinted substrate 400, both sets of imprinted information are clearly visible on the front side of the placard 600. FIG. 6B depicts the top part 490 of the transparent label 400 folded over a top part of the substrate 300 and the bottom part 495 of the transparent label 400 folded over a bottom part of the substrate 300, the top and bottom parts being adhered to the back of the substrate 300.

Although the present invention has been described in detail with reference to certain preferred embodiments, it should be apparent that modifications and adaptations to those embodiments might occur to persons skilled in the art without departing from the spirit and scope of the present invention.

1. A method for fabricating informational placards, comprising the steps of:
entering a name of an applicant for an informational placard and an issuing agent of an informational placard into a computer system by a system user via a user interface for obtaining an informational placard;
determining an expiration date of the informational placard based on the current date by the computer system;
entering a vehicle identification number into the computer system by the system user via the user interface for accessing information on a vehicle identified by the vehicle identification number from a database;
accessing information required by regulatory agencies on informational placards from a database by the computer system;
printing the required information on a substrate using a printer connected to the computer system to form the informational placard containing the expiration date, the vehicle identification number and the information required by regulatory agencies; and
positioning the informational placard on the identified vehicle.

2. The method of claim 1, wherein the step of entering a name of an applicant for an informational placard comprises selecting the name of the applicant from a list of applicants presented to the user via the user interface, the list of applicants accessed from a database.

3. The method of claim 1, wherein the step of entering a name of an issuing agent of an informational placard comprises selecting the name of the issuing agent from a list of issuing agents presented to the user via the user interface, the list of issuing agents accessed from a database.

4. The method of claim 1, wherein the step of determining an expiration date further comprises adding a time duration period to the current date, the added time duration being determined by regulatory requirements.

5. The method of claim 1, wherein the step of entering a vehicle identification number comprises scanning a bar code representation of the vehicle identification number into the computer system using a bar code scanner.

6. The method of claim 1, wherein the step of accessing information is selected from the group consisting of accessing a driver permit number of the placard applicant, assessing a serial number, accessing specific vehicle information, accessing an issuer permit number of the issuer agent, accessing a name of a vehicle dealership, accessing a dealer permit number of a vehicle dealership, accessing a location of a vehicle dealership, and accessing template information regarding placard size and placard information requirements.

7. The method of claim 1, wherein the step of printing the required information on a substrate is selected from the group consisting of printing on a substrate using a laser printer, printing on a substrate using an inkjet printer and printing on a substrate using a thermal printer.

8. The method of claim 1, wherein the step of printing on a substrate to form an informational placard comprises:
printing the required information on a label using a printer connected to the computer system, the label imprinted with variable information including the expiration date and the vehicle identification number and fixed information required by regulatory agencies; and
affixing the label to a substrate using an adhesive means to form an informational placard.

9. The method of claim 1, wherein the step of printing on a substrate to form an informational placard comprises:
printing the required information on an optically opaque label using a printer connected to the computer system, the label imprinted with variable information including the expiration date and the vehicle identification number and fixed information required by regulatory agencies; and
affixing the label to a blank substrate using an adhesive means to form an informational placard.

10. The method of claim 1, wherein the step of printing on a substrate to form an informational placard comprises:
printing the required information on an optically transparent label using a printer connected to the computer system, the label imprinted with variable information including the expiration date and the vehicle identification number and fixed information required by regulatory agencies; and
affixing the label to a blank substrate using an adhesive means to form an informational placard.

11. The method of claim 1, wherein the step of printing on a substrate to form an informational placard comprises:
printing the required information on an optically transparent label using a printer connected to the computer system, the label imprinted with variable information including the expiration date and the vehicle identification number; and
affixing the label to a pre-printed substrate containing fixed information required by regulatory agencies using an adhesive means to form an informational placard.

12. The method of claim 11, wherein the step of affixing the optically transparent label to the pre-printed substrate comprises positioning the transparent label on the substrate by aligning label printed characters with corresponding character positions imprinted on the substrate and securing the transparent label to the substrate using weatherproof adhesive means.

13. The method of claim 1, wherein the step of positioning the informational placard is selected from the group consisting of positioning the informational placard in a license plate holder of the identified vehicle, positioning the informational placard in a window of the identified vehicle, and positioning the informational placard on a bumper of the identified vehicle.

14. The method of claim 8, wherein the label is pre-printed with fixed information determined by regulatory requirements.

15. The method of claim 14, wherein the pre-printed fixed information is selected from the group consisting of background designs, colors, watermarks, distinguishing features and a refractive image.

16. The method of claim 1, wherein the step of accessing information is selected from the group consisting of accessing information by a standalone computer system connected to a local database, accessing information by a client-server computer system connected to a database, accessing information by a computer system connected to a remote database system via the Internet, and accessing information by a computer system connected to a remote database system via a data communications network.

17. A system for fabricating informational placards, comprising:
a user interface for entering a name of an applicant for an informational placard and an issuing agent of an informational placard into a computer system by a system user for obtaining an informational placard;
computer means for determining an expiration date of the informational placard based on the current date;
means for entering a vehicle identification number into the computer system by the system user via the user interface for accessing information on a vehicle identified by the vehicle identification number from a database;
means for accessing information required by regulatory agencies on informational placards from a database by the computer system;
means for printing the required information on a substrate using a printer connected to the computer system to form an informational placard containing the expiration date, vehicle identification number and the information required by regulatory agencies; and
means for positioning the informational placard on the identified vehicle.

18. The system of claim 17, further comprising the user interface for displaying a list of names of applicants for informational placards accessed from a database, a name of an applicant for an informational placard being selected from the list of names of applicants by a user.

19. The system of claim 17, further comprising the user interface for displaying a list of names of issuing agents of informational placards accessed from a database, a name of an issuing agent being selected from the list of names of issuing agents by a user.

20. The system of claim 17, wherein the means for entering a vehicle identification number comprises a bar code scanner for scanning a bar code representation of the vehicle identification number into the computer system.

21. The system of claim 17, wherein the information required on informational placards by regulatory agencies is selected from the group consisting of a driver permit number of the placard applicant, a serial number, specific vehicle information, an issuer permit number of the issuer agent, a name of a vehicle dealership, a dealer permit number of a vehicle dealership, a location of a vehicle dealership, and template information regarding placard size and placard information requirements.

22. The system of claim 17, wherein the means for printing the required information is selected from the group consisting of a laser printer, an inkjet printer and a thermal printer.

23. The system of claim 17, wherein the substrate comprises a material selected from the group consisting of paperboard, cardboard, metal and plastic.

24. The system of claim 17, wherein the substrate is pre-printed with fixed information determined by regulatory requirements.

25. The system of claim 24, wherein the pre-printed fixed information is selected from the group consisting of background designs, colors, watermarks, distinguishing features and a refractive image.

26. The system of claim 17, wherein the means for printing on a substrate to form an informational placard comprises:
means for printing the required information on a label using a printer connected to the computer system, the label imprinted with variable information including the expiration date and the vehicle identification number and fixed information required by regulatory agencies; and
adhesive means for affixing the label to a substrate to form an informational placard.

27. The system of claim 17, wherein the means for printing on a substrate to form an informational placard comprises:
means for printing the required information on an optically opaque label using a printer connected to the computer system, the label imprinted with variable information including the expiration date and the vehicle identification number and fixed information required by regulatory agencies; and
adhesive means for affixing the label to a blank substrate to form an informational placard.

28. The system of claim 17, wherein the means for printing on a substrate to form an informational placard comprises:
means for printing the required information on an optically transparent label using a printer connected to the computer system, the label imprinted with variable information including the expiration date and the vehicle identification number and fixed information required by regulatory agencies; and
adhesive means for affixing the label to a blank substrate to form an informational placard.

29. The system of claim 17, wherein the means for printing on a substrate to form an informational placard comprises:
means for printing the required information on an optically transparent label using a printer connected to the computer system, the label imprinted with variable information including the expiration date and the vehicle identification number; and
adhesive means for affixing the label to a pre-printed substrate containing fixed information required by regulatory agencies to form an informational placard.

30. The system of claim 17, wherein the information placard is selected from the group consisting of a temporary license plate and a disabled parking placard.

31. The system of claim 17, wherein the formed informational placard is durable, tamper resistant and weather resistant.

32. The system of claim 26, wherein the label is pre-printed with fixed information determined by regulatory requirements.

33. The system of claim 32, wherein the pre-printed fixed information is selected from the group consisting of background designs, colors, watermarks, distinguishing features and a refractive image.

34. The system of claim 17, wherein the means of accessing information is selected from the group consisting of a standalone computer system connected to a local database, a client-server computer system connected to a database, a computer system connected to a remote database system via the Internet, and a computer system connected to a remote database system via a data communications network.

35. A system for fabricating informational placards, comprising:
a computer connected to a user interface, at least one database, a barcode scanner, and a printer;
a substrate imprinted with information by the printer to form an informational placard; and
means for displaying the informational placard.

36. The system of claim 35, wherein the imprinted information on the substrate is selected from the group consisting of variable information, and fixed plus variable information.

37. The system of claim 35, wherein the information imprinted on the information placard conforms to regulatory agency requirements.

38. The system of claim 35, wherein the substrate comprises:
a label imprinted with information; and
a substrate for adhesively mounting the label.

39. The system of claim 38, wherein the label is pre-printed with information.

40. The system of claim 38, wherein the substrate is pre-printed with information.
